(19) United States
(12) Patent Application Publication
(10) Pub. No.: US 2013/0157036 A1
(43) Pub. Date: Jun. 20, 2013

(54) FIREPROOF GLAZING

(71) Applicants: Guillaume Herremans, Jumet (BE); Thomas Lescot, Jumet (BE)

(72) Inventors: Guillaume Herremans, Jumet (BE); Thomas Lescot, Jumet (BE)

(73) Assignee: AGC Glass Europe, Bruxelles (Watermael-Boitsfort) (BE)

(21) Appl. No.: 13/820,013

(22) PCT Filed: Aug. 31, 2011
(86) PCT No.: PCT/EP2011/064946

§ 371 Date: Feb. 28, 2013

(30) Foreign Application Priority Data
Sep. 3, 2010 (BE) BE 2010/0528

(51) Int. Cl. C03C 17/23

(52) U.S. Cl. CPC C03C 17/23
USPC 428/220; 427/162

(57) ABSTRACT

The invention relates to fireproof glazing comprising at least one intumescent layer of hydrated alkaline silicate having a thickness of no less than 2.5 mm and containing water and optionally compounds partially substituting the water, namely either glycerin or ethylene glycol, said compounds and water combined representing between 25 and 45 wt.-% of the layer, with a molar ratio SiO₂/M₂O of between 2.5 and 6. The viscosity of the intumescent layer prevents the layer from creeping over time.

The present invention relates to fire-resistant glazing systems that comprise one or more layers of hydrated alkali silicates between glass sheets. These layers of silicates are such that when exposed to the fire test they form a foam that shields against radiation and holds the glass sheets in place even after they have been cracked under the effect of thermal shock.

Fire-resistant glazing systems of this type are well known, as are the performances that are expected of them. The most important of these is, of course, the ability to withstand the fire test for as long as possible. The “fireproof” quality consists of the resistance to flames, but also the ability to shield against radiation that is likely to cause propagation of the fire.

Performance levels in this field are sensitive to the laminated structure utilised but also to the composition of the silicate layers used. Hence, the multiplicity of glass sheets and also of layers is a well known factor that enables the performance to be increased. The “refractory” nature of the glazing and its fire-resistance quality are also dependent on increasing the SiO₂/M₂O molar ratio, where M is an alkali metal or a mixture thereof. The water content to a certain extent is also a factor that enables the fire-resistance to be increased.

Fire-resistant glazing systems must also exhibit optical qualities. Their most frequent use requires in particular that they are transparent. For this property the glazing systems must not only provide a good light transmission, but must additionally have no flaws. Depending on the production methods, these are the presence of bubbles in the silicate, for example, or even the formation of a more or less pronounced haze that leads, on the one hand, to a quite significant diffusion of the transmitted light. These flaws appear either upon formation of the glazing or more often over time, and their formation can be accelerated by exposing the glazing to certain conditions (elevated temperature; UV irradiation).

The qualities required of these glazing systems also include mechanical characteristics. Depending on their use, for example, it is required that these glazing systems can withstand standardised shocks that simulate the impact from a person. These characteristic features are again associated with the chosen laminated structures, the possible use of known interlayer sheets for improving the mechanical resistance of glazing systems such as the presence of PVB sheets, but also with the compositions of the alkali silicates used. The structure of fire-resistant glazing systems is itself also likely to be affected by a lack of adequate stability of the assemblies formed.

Very rigorous production techniques enable the formation of these flaws to be prevented or at least limited so that they are not unacceptable. These techniques concern in particular the procedures followed during preparation of the alkali silicate layers, whether these are the result of drying or dehydration operations or any other technique that results in the desired compositions, in particular the formation of these silicates by reacting colloidal silica and alkali hydroxide. However, they also concern the constituents of these compositions and the combination thereof.

As an indication, the ageing property of the layers can depend on the concentration of water and/or hydroxylated compounds (ethylene glycol, glycerine . . . ). The effect of one or other of the constituents of the compositions considered on the properties of the layers is equally applicable to all these constituents. Therefore, there are many compromises that lead to the choice of these constituents. We have referred to some considerations relating to the water content above. There are others that are at least of equal importance.

A particular consideration relates to the preparation conditions. Traditionally, the compositions are prepared from industrial silicate solutions. The stability of these solutions limits the content of dry substance that they contain and this is all the more the case when the SiO₂/M₂O molar ratio is higher. Moreover, where possible, the economy of production causes the drying operations to be limited. The composition of the final layer in particular is a result of compromise. For the use of compositions of high molar ratio the starting solution must contain little dry substance. However, solutions of high molar ratio require more significant drying to attain the final contents that relate to the intumescent layer.

What has been indicated with respect to water must be corrected to take into consideration the possible presence of hydroxylated compounds that traditionally also occur in these compositions, in particular ethylene glycol or glycerine. These hydroxylated constituents are partly substituted for water in the composition of the intumescent layers and also give the layers containing them a certain plasticity. They also contribute to the frost resistance of the glazing systems.

While the refractory character of the composition is advantageous to fire resistance, this character conversely makes the compositions less plastic and the impact resistance levels thereof are reduced. However, the plasticity that enables the impact resistance to be improved must be properly controlled. The increase in water content and hydroxylated compounds that increases this plasticity can result in a certain structural instability if this content it too high. The intumescent products, particularly if they are in relatively thick layers and in glazing systems of large dimensions, can have a tendency to creep under their own weight, which leads to a deformation of the glazing and an unacceptable distribution of the intumescent product.

The inventors have sought a way of reconciling the different properties of these products, i.e. that they are simultaneously as effective as possible with respect to their fire resistance, provide a good mechanical impact resistance, age without unacceptable deterioration and their preparation is organised from abundant and inexpensive products without requiring too complex an operation.

In the prior art the choice of the nature of the silicates has been left to the technician. The different sources and the very nature itself of the silicate or silicates have seemingly been dictated primarily by practical or economic aspects. The inventors have shown that the characteristics of the silicates concerned were far from being equivalent in the determination of the properties of the layers.

The object for the inventors is to undertake to determine multiple conditions and interactions thereof to obtain intumescent products.

The invention relates to fireproof glazing systems that, particularly when they include relatively thick intumescent layers, do not lead to a deformation as a result of creep under the effect of their own weight. Depending on the compositions, it appears that products that otherwise meet the requirements outlined above could prove to be unacceptable simply due to observation of a deformation consistent with an increase in thickness in the lower portion of the glazing and a corresponding decrease in thickness at the top thereof, as a result of being stored in a vertical position for long periods. These deformations essentially appear in relatively thick intumescent layers. For the most usual products the intumescent layers have a thickness in the order of a millimetre. The creep phenomena caused are practically imperceptible at this thickness. It is a different matter when these layers exceed 2 mm, particularly when the heights are more significant.

The inventors have established that the viscosity of the products must be sufficient to ensure that the layer will be kept without unacceptable deformation even in glazing systems of large dimensions (several metres). Advantageously, the viscosity of the intumescent layers according to the invention is at least equal to 0.8.10⁹ Pa.s, preferably at least equal to 1.10⁹ Pa.s.

Viscosity is measured in accordance with standard ASTM C 1351M-96 in the following application conditions:
a load of 20N
measurement temperature 25° C.
dimension of the sample of intumescent material 12 mm
height of the sample 8.5 to 9.5 mm.

The intumescent material is placed between two glass sheets each with a thickness of 3 mm.

Moreover, the layers according to the invention have a thickness of at least 2.5 mm and preferably at least 3 mm, an SiO₂/M₂O molar ratio of 2.5 to 6 and have a water content and a content of hydroxylated compounds such as glycerine or ethylene glycol representing 25% to 45% of the weight of the layer.

Compositions that have these viscosities can be arranged in relatively thick layers without causing any deformation of the glazing as a result of creep.

The effect on properties of the nature of the alkali metals used has been demonstrated by the inventors in the choices made of components of intumescent layers. Thus, all things being equal, it appears that sodium silicates provide the best results in the formation of thick layers that have a good resistance to creep.

Of the other alkali metals present potassium is preferred. It provides layers with a particularly favourable refractory character. Lithium can also be present. However, because of its characteristics it is preferable to limit its content. It preferably represents not more than 10 atom. % of all the alkali metals.

In accordance with these observations, the inventors propose that glazing systems according to the invention comprise intumescent layers with a thickness of at least 2.5 mm and preferably at least 3 mm, still having a water content and content of hydroxylated compounds such as glycerine or ethylene glycol representing 25% to 45% of the weight of the layer, that they comply with one of the following ii combinations of conditions between the Na₂O/M₂O molar ratio, the content by weight of water and hydroxylated compounds (W+H) and the R_{M} SiO₂/M₂O molar ratio (M being the sum of Na and K):
Na₂O/M₂O of 67% to 100% and W+H of 40% to 45% R_{M}>3.5 or W+H of 35% to 40% R_{M}>2.75 or W+H of 25% to 35% R_{M}>2.25
Na₂OM₂O of 34% to 66% and W+H of 40% to 45% R_{M}>4.25 or W+H of 35% to 40% R_{M}>4.0 or W+H of 30% to 35% R_{M}>3.75 or W+H of 25% to 30% R_{M}>3.5
Na₂O/M₂O of 0% to 33% and W+H of 40% to 45% R_{M}>4.75 or W+H of 35% to 40% R_{M}>4.5 or W+H of 3o% to 35% R_{M}>4.25 or W+H of 25% to 30% R_{M}>4.0.

The thicknesses of layers likely to be used can reach or exceed 8 mm. However, most frequently, the layers in question do not exceed 6 mm and most often do not exceed 4 mm. In all cases, to ensure that the viscosity is of significant importance, the intumescent layers must have a thickness of at least 2.5 mm.

The layers are all the more sensitive to creep when they are thicker. Consequently, the viscosity is advantageously higher when the thickness is greater. This is also reflected in the choice of the most appropriate compositions. In the case of very thick layers, it is preferred, for example, to use a composition in which the sodium content is very high, or even a composition that contains less water and hydroxylated compounds.

To meet satisfactory conditions, the silicon/alkali metal molar ratio ranges between 2.5 and 6 and preferably 3 to 6, particularly preferred 3.5 to 5. The water content in the intumescent layer ranges between 25% and 45% by weight of the layer, preferably between 30% and 40% by weight.

If the water content is from 25% to 45% by weight of the layer, as indicated above, products with a low molecular mass containing hydroxyl functional groups can be substituted at least partially for the water. Advantageously, 2% to 15% by weight and preferably 4% to 10% by weight of glycerine or ethylene glycol are introduced.

In the preparation of the compositions used to form these intumescent layers it is advantageous to proceed at least partly by forming the alkali silicate by reacting alkali hydroxide and colloidal silica. This preparation, as evident from the prior art, allows a high molar ratio to be combined with a relatively short drying step. Although solutions of silicate with a high molar ratio in principle require a high water content to prevent a spontaneous expansion that is all the more rapid when the ratio is higher, the composition in question does not need to be kept over long periods and its stability is sufficient and can be further improved if the composition is refrigerated.

The preparation can combine the use of commercially available alkali silicate solutions and products of the above-described reaction. These combinations when properly measured out allow the indicated advantages of a preparation starting from colloidal silica and alkali hydroxide and those associated with the low cost of commercial silicate solutions to be combined, if need be.

Advantageously, in the preparation of compositions at least 20% of the silica present comes from colloidal silica. This proportion is preferably higher than 30% and particularly preferred more than 40%.

The composition of the layers can also contain various additives in limited proportions. These additives are intended in particular to improve stability over time of the layers or their mechanical properties, or even the interface between the glass sheets. When present, the additives advantageously do not constitute more than 6% of the weight of the layer.

Included among the additives used in particular are aminated products such as tetramethylammonium hydroxide (TMAH), which when present does not represent more than 2% by weight of the layer.

Other additives are formed by organosilic compounds, in particular tetraethyl orthosilicate (TEOS) or methyltriethoxysilane (MTEOS). These products promote the plasticity of the layers.

Fireproof glazing systems comprising the intumescent layers described above are formed either by pouring the composition into a delimited space between two glass sheet with a sealing strip assuring the seal along the periphery of the glazing systems, or by applying the composition to a horizontal sheet and partially drying this layer.

In a first embodiment the initial composition is prepared so that it spontaneously leads to quite a rapid expansion. This expansion is possibly accelerated by moderate heating of the composition. An advantage of this type of preparation is that it is not dependent on a quite lengthy drying operation. The thickness of the intumescent layers is not limited by the drying time that increases as the thickness of the layers increases. The absence of creep is particularly important with respect to these very thick layers.

To form relatively thick intumescent layer using drying techniques, it is preferable to join two sheets that each bear a previously formed layer. The total thickness is thus divided and the total drying time is substantially reduced in relation to the time that would be necessary to dry a single layer of the total thickness.

In the preparation technique comprising drying starting from a stable solution, it is preferable to ensure that this drying is as limited as possible, since the cost of the operation is linked to the time required. For this reason, prior to its application onto the glass sheet, the composition is brought to a water content that is sufficiently low to allow stability of this composition. As indicated above, the at least partial use of colloidal silica in this preparation is particularly recommended. Whatever the method of preparation, the stability of these compositions that must be dried is dependent on the water content and the content of hydroxylated compounds. This stability is assured when this content is substantially at least equal to 50% by weight of the composition.

Whether the composition is dried or is such that it spontaneously expands, the initial water content is advantageously adjusted by a dehydration operation conducted immediately before the solution is used. Such a dehydration operation is carried out on a solution directed onto a layer of low thickness in vacuum and possibly at moderate temperature. The details of the drying are described in detail in the published application WO 2010/055166.

The invention is described in detail in the following examples of compositions and thickness of the layers.

The nature of the composition of the silicate is given in the following table in atomic percentage of sodium in mixed silicates of sodium and potassium. The table also includes the molar ratio R_{M}, the content by weight of water in the layer, that of glycerine (G) and that of TMAH. Finally, the table indicates the thickness in mm of the layer formed.

| No. | Na % | R_{M} | H₂O | G | TMAH | thickness |
|---|---|---|---|---|---|---|
| 1 | 100 | 4.3 | 36 | 5 | 1 | 3.6 |
| 2 | 100 | 4.3 | 33 | 5 | 1 | 3.7 |
| 3 | 50 | 4.3 | 30 | 6 | 0 | 3.3 |
| 4 | 50 | 4.6 | 41 | 5 | 1 | 3.9 |
| 5 | 50 | 5.2 | 34 | 5 | 1 | 4.0 |
| 6 | 0 | 5.2 | 32 | 6 | 1 | 4.0 |
| 7 | 0 | 5.2 | 30 | 5 | 1 | 4.2 |
| 8 | 100 | 4.6 | 39 | 5 | 1 | 3.2 |
| 9 | 100 | 5.7 | 40 | 5 | 0.5 | 3 |
| 10 | 100 | 2.25 | 28 | 4 | 1 | 2.9 |
| 11 | 100 | 5.5 | 30 | 5 | 0.5 | 3.1 |
| 12 | 50 | 4.75 | 37.5 | 5 | 0 | 3.2 |
| 13 | 50 | 5.4 | 29 | 3 | 0 | 3.3 |
| 14 | 0 | 5.8 | 38 | 4 | 0.5 | 3.1 |
| 15 | 0 | 5.2 | 29 | 4 | 0 | 3.0 |

The formed layers pass the creep test successfully with the exception of example 4 that falls short of the characteristics of the invention. In this example the tendency to creep results from too strong a combination comprising water and glycerine that does not adequately offset the sodium silicate content. This example is to be compared with examples 8 or 9, which with a similar water and glycerine content, but exclusively sodium silicate provide good resistance to creep.

The viscosities measured in the conditions indicated above range between 1.10⁹ and 1.10¹⁰ Pa.s, except for example 4, in which the viscosity amounts to around 0.6 10⁹ Pa.s

1. Fire-resistant glazing comprising at least one intumescent layer of hydrated alkali silicate, the thickness of which is not less than 2.5 mm, which contains water and possibly hydroxylated compounds that are partly substituted for this, said compounds being either glycerine or ethylene glycol, wherein those with water are present to an amount of 25% to 45% by weight of the layer, and with an SiO₂/M₂O molar ratio of 2.5 to 6, and the intumescent layer has a viscosity that is not less than 0.8. 10⁹ Pa.s and is preferably not lower than 1.10⁹ Pa.s measured in accordance with standard ASTM C1351M-96.

2. Fire-resistant glazing comprising at least one intumescent layer of hydrated alkali silicate, the thickness of which is not less than 2 mm, which contains water and possibly hydroxylated compounds (H) that are partly substituted for this, said compounds being either glycerine or ethylene glycol, wherein the alkali silicate is a mixed silicate constituent of sodium and potassium complying with one of the following combinations of conditions between the Na₂O/M₂O molar ratio, the content by weight of water and hydroxylated compounds (W+H) and the R_{M} SiO₂/M₂O molar ratio (M being the sum of Na and K):
Na₂O/M₂O of 67% to 100% and W+H of 40% to 45% R_{M}>3.5 or W+H of 35% to 40% R_{M}>2.75 or W+H of 25% to 35% R_{M}>2.25
Na₂O/M₂O of 34% to 66% and W+H of 40% to 45% R_{M}>4.25 or W+H of 35% to 40% R_{M}>4.0 or W+H of 30% to 35% R_{M}>3.75 or W+H of 25% to 30% R_{M}>3.5
Na₂O/M₂O of 0% to 33% and W+H of 40% to 45% R_{M}>4.75 or W+H of 35% to 40% R_{M}>4.5 or W+H of 30% to 35% R_{M}>4.25 or W+H of 25% to 30% R_{M}>4.0.

3. Glazing according to claim 2, in which the intumescent layer has a thickness at least equal to 2.5 mm.

4. Glazing according to one of the preceding claims, in which the content of glycerine or ethylene glycol of the intumescent layer is in the range of between 2% and 15% by weight.

5. Glazing according to one of the preceding claims, in which at least 20% of the silica present in the intumescent layer comes from colloidal silica used during the preparation of the composition that leads to the intumescent layer.

6. Glazing according to one of the preceding claims, in which the intumescent layer is formed from sodium and/or potassium silicate and in addition thereto lithium is present to 10 atom. % at most of all the alkali metals.

7. Glazing according to one of the preceding claims, in which the SiO₂/M₂O molar ratio amounts to 3 to 6.

8. Glazing according to one of the preceding claims, in which the intumescent layer also contains additives in proportions by weight that do not exceed 6% of the entire intumescent layer.

9. Glazing according to claim 8, in which included among the additives present in the layer in particular are one or more compounds of the group comprising aminated compounds and organic compounds of silicon.

10. Glazing according to claim 9, in which TMAH is included among the additives with a content that does not exceed 2% by weight of the intumescent layer.

11. Glazing according to claim 9, in which TEOS and/or MTEOS are included among the organic compounds of silicon.

12. Process for the production of fire-resistant glazing according to one of the preceding claims, in which to produce the intumescent layer, a starting solution is prepared, in which the initial content of water and glycerine and ethylene glycol is at least equal to 50% by weight of this solution, wherein the solution used to form the intumescent layer is brought to the final values by drying after it has been applied to a support or by dehydration preferably in vacuum conducted on the solution itself.

13. Process according to claim 16?, in which the starting solution is formed at least partially from industrial alkali silicate, wherein the complement results from the reaction of a suspension of colloidal silica and alkali hydroxide.
